(19) United States
(12) Patent Application Publication
(10) Pub. No.: US 2013/0191037 A1
(43) Pub. Date: Jul. 25, 2013

(54) CHARACTERIZATION OF PARTICULATES USING ELECTRON MICROSCOPY AND IMAGE PROCESSING METHODS

(71) Applicants: Anke MULDER, La Jolla, CA (US); Bridget CARRAGHER, San Diego, CA (US); Clinton POTTER, San Diego, CA (US)

(72) Inventors: Anke MULDER, La Jolla, CA (US); Bridget CARRAGHER, San Diego, CA (US); Clinton POTTER, San Diego, CA (US)

(73) Assignee: NANOIMAGING SERVICES, La Jolla, CA (US)

(21) Appl. No.: 13/559,138

(22) Filed: Jul. 26, 2012

Related U.S. Application Data
(60) Provisional application No. 61/511,909, filed on Jul. 26, 2011.

(51) Int. Cl. G01N 15/02

(52) U.S. Cl. CPC G01N 15/02
USPC 702/29

(57) ABSTRACT

It is an object of the invention to provide methods and compositions for characterizing particles in a size range from about 1 μm to about 10 nm, and preferably 5 μm to about 5 nm. Using transmission electron microscopy and digital image processing techniques, the methods of the present invention can provide detailed information on the aggregation state of, for example, proteinaceous samples such as antibody-based pharmaceutical compositions. The methods can further permit assessment of the effect of storage, use, processing, and shipping conditions in such proteinaceous samples.

### CROSS REFERENCE TO RELATED APPLICATIONS

The present invention claims priority from U.S. Provisional Patent Application No. 61/511,909, filed Jul. 26, 2011, which is hereby incorporated in its entirety including all tables, figures, and claims.

### BACKGROUND OF THE INVENTION

The following discussion of the background of the invention is merely provided to aid the reader in understanding the invention and is not admitted to describe or constitute prior art to the present invention.

Biopharmaceuticals currently represent a significant portion of drugs in the global pharmaceutical pipeline, and in recent years, antibodies have become an increasing percentage of biopharmaceuticals due to their therapeutic efficacy and biocompatibility. The propensity of protein molecules to aggregate into dimeric and oligomeric structures has been noted as a concern for both the FDA and the biopharmaceutical companies. Such proteinaceous particles can, under certain circumstances, elicit an immune response in the patient, which could eventually render the drug ineffective. Thus, biopharmaceutical companies have begin routine quantification of particles as small as one to two microns.

Microscopy and light obscuration methods are routinely used for detecting and counting subvisible particles according to United States Pharmacopeia (USP) chapter 788. When these methods are correlated to the apparent globular size of the aggregate detected, there is a size gap in the capability of methods used to detect and monitor small aggregates that range between a few nanometers and about 1 um in diameter, with an emphasis on aggregates between 100 nm and 1 um, and the methods used to detect and monitor large aggregates that range between a few micrometers and about 50 μm in diameter. This gap may pose a problem because the ability to detect, measure, and evaluate the fate of some small aggregates as well as the precursors of larger aggregates may not be implemented in protein aggregate control strategies. In fact, it has been pointed out that aggregates with apparent globular diameters around 0.5 μm are not routinely tracked and analyzed.

In addition to aggregate size, biopharmaceutical companies monitor the rate of aggregate change in size over time, where time corresponds to the protein product lifecycle, is a useful parameter that can provide a functional characterization of aggregates. An aggregate can initially exist as a small dimer or fragment, and progress toward larger structures, such as subvisible or visible particles, if such a transition becomes thermodynamically favorable. At any given moment, a protein may be transitioning between a thermodynamic state that favors the monomer or native configuration of the protein, and an intermediate state that favors an unfolded native-like protein configuration. Under the right set of conditions, the unfolded protein may form a complex with other native and non-native forms, gaining enough free energy to transition to an aggregated state that may become the most stable state of the new proteinaceous entity. Stable protein preparations will have aggregates present in a solution of a heterogeneous nature, but the rate of growth is minimal compared with more unstable preparations. Aggregates that have increased rates of growth are more worrisome and more aggressive strategies of control and minimization may be needed.

### BRIEF SUMMARY OF THE INVENTION

It is an object of the invention to provide methods and compositions for characterizing particles in a size range from about 1 μm to about 10 nm, and preferably 5 μm to about 5 nm. Using transmission electron microscopy and digital image processing techniques, the methods of the present invention can provide detailed information on the aggregation state of, for example, proteinacous samples such as antibody-based pharmaceutical compositions. The methods can further permit assessment of the effect of storage, use, processing, and shipping conditions in such proteinaceous samples.

In a first aspect, the present invention provides methods for assigning a size distribution and aggregation metric to particles contained in an aqueous sample. The particles size assessed is preferably less than or equal to about 1, and preferably 5, μm in diameter in a non-aggregated state. These methods comprise:
a. collecting one or more transmission electron images of the aqueous sample at each of a plurality of different magnification levels, wherein each magnification level is between about 2000× and about 100,000×;
b. for each particle in a population of n particles identified in the images collected, determining a value for the surface area of the particle, and determining a particle size from the surface area value;
c. determining a distribution of the particle sizes of the n particles;
d. determining an aggregation metric for the n particles.

The term “transmission electron image” refers to a micrograph recorded using a transmission electron microscope. Transmission electron microscopy (TEM) is a microscopy technique whereby a beam of electrons is transmitted through an ultra thin specimen, interacting with the specimen as it passes through. An image is formed from the interaction of the electrons transmitted through the specimen; the image is magnified and focused onto an imaging device, such as a fluorescent screen, on a layer of photographic film, or to be detected by a sensor such as a CCD camera. The image is in effect assumed to be a simple two dimensional projection of the sample down the optical axis.

The term “particle” as used herein refers to a discrete object which can be visualized in a transmission electron microscope image, and to which can be ascribed one or more physical properties such as volume or mass based on the electron image of the particle. In certain embodiments, a particle refers to one or more proteinaceous structures such as antibodies. By way of example, an antibody particle can comprise a single antibody molecule (a monomer) or be an aggregation comprising two or more antibody molecules.

The term “particle size distribution” as used herein refers to a list of values or a mathematical function that defines the relative amounts of particles present, sorted according to size.

The term “aggregation metric” as used herein refers to a single value used to represent the area in an image that is taken up by non-monomeric (aggregated) particles. By way of example, the surface area value determined for every aggregated particle in a particular image can be summed (e.g., resulting in ΣSAₚ measured in nm²). The total area of the corresponding image can also be determined (e.g., resulting in ΣSA, also measured in nm²), and the aggregation metric calculated as ΣSAₚ/ΣSAᵢ.

As used herein, the term “surface area” as applied to images of particles in projection refers to the area bounded by a contour line drawn around the particle. From the surface area, a number of metrics are known in the art and may be employed in the claimed methods to condense irregular shape data into a single value representing the particle size. These include the Diameters Derived from the Equivalent Circle, the Diameter of a Circle of Equal Projection Area, the Diameter of a Circle of Equal Perimeter, the Feret Diameter, the Feret Diameter Mean Value, the Feret Diameter 90° to the Maximal Feret Diameter, the Feret Diameter 90° to the Minimal Feret Diameter, the Minimum Area Bounding Rectangle, the Chord Length, and the Martin Diameter. This list is not meant to be limiting.

In certain embodiments, the present invention can include one or more additional characterizations of the particles contained in the aqueous sample.

For example, a shape metric may be assigned to each particle in the population of n particles. The term “shape metric” as used herein refers to a single value used to represent the irregular shape data of particles obtained from projection images. In preferred embodiments, the shape metric is determined by calculating a ratio of the maximum and minimum Feret diameter for each particle, a value known as the Feret aspect ratio.

In another example, a particle count metric may be assigned to the sample. The term “particle count” as used herein refers to the number of particles in the desired size range observable by the claimed methods per some unit of measure. Thus, the number of particles (n) may be counted on the images collected, and the value converted to a number of particles per image, a number of particles per volume (e.g., n/μL or n/mL of sample), a number of particles per weight of protein in the sample (e.g., n/mg or n/μg), etc. This list is not meant to be limiting.

In certain aspects, the sample may be assessed for changes in particle characteristics resulting from some perturbation of the sample. Examples of such perturbations include storage or handling conditions, freeze thaw cycle(s), elevated temperatures, storage time, freeze-drying (lyophylization), changes in container materials (e.g., plastic vs glass vs siliconized glass), changes in volume, changes in protein concentration, agitation (shaking, stirring, etc.), or adding additional active ingredients or excipients (e.g, antioxidants, redox buffers, pH buffers, antiadherents, stabilizers, surfactants, binders, coatings, disintegrants, fillers, diluents, flavours, colours, lubricants, glidants, preservatives, sorbents, sweeteners, etc.).

Such changes in particle characteristics may be examined by calculating a monomer loss metric for the particles contained in the aqueous sample. As used herein, the term “particle loss metric” refers to a number reflective of a change in the total number of particles in the desired size range observable by the claimed methods per some unit of measure observable between two sets of sample conditions.

As noted above, images are recorded at a plurality of magnification levels. These magnifications are selected to image particles of desired sizes within the “size gap” noted above. These magnifications are preferably selected between about 2000× and about 100,000×. For example, a magnification of about 6,500× would be appropriate for particles sizes of about 1 μm; a magnification of about 21,000× appropriate for particles sizes of about 100 nm; and a magnification of 52,000× appropriate for particles sizes of about 10 nm. The term “about” as used herein refers to +/−10% of a given measurement.

The number of particles which must be analyzed depends on the desired statistical power of the analysis. Suitable numbers are at least 10 particles, more preferably at least 50 particles, still most preferably at least 100 particles, and yet more preferably at least 500 particles or more. To assist in analyzing an increasingly large number of particles, an automated procedure for identifying particles and calculating the necessary parameters is described hereinafter. The term “automated analysis” as used herein refers to a computational procedure which identifies particles in an image and determines parameters such as surface area of the particle, particle size, and aggregation metric by computer without human intervention. In certain embodiments, the automated analysis system extends to computer control of the recording of electron images from a specimen.

The methods of the present invention may be used to analyze particles selected from the group consisting of polymer beads, metal beads, proteins, protein-metal bead complexes, protein-polymer bead complexes, viruses, virus-like particles, and liposomes. Preferred specimens are proteins of pharmaceutical interest, such as therapeutic antibodies. In view of the interest of regulatory agencies in obtaining information on the aggregation of such therapeutic proteins, the method can be performed by a service provider as a service for a customer, and the method can further comprise generating a report of the results obtained from the method for delivery to the customer.

### DETAILED DESCRIPTION OF THE INVENTION

### Causes of Aggregation Effects

Drug product aggregates may originate from multiple sources and various types of aggregates may be present in a given drug product vial. The potential for protein aggregate formation exists at all levels of protein-based pharmaceutical manufacturing. Starting with the sequence and characterization of the protein, each protein will have physicochemical characteristics that can render it more or less stable. For example, the presence of free cysteines in antibody molecules can encourage aggregation through disulphide bond formation. In addition, antibodies intended for pharmaceutical use may be expressed and stored at high concentrations that favor the increased incidence of molecular interaction, and therefore, the potential for aggregate formation. Manufacturers therefore dedicate much time and effort to developing a formulation that will keep the protein drug product stable during its lifecycle, whether in solution or lyophilized. Understanding the stability profile at the level of aggregate structure aids this effort.

Protein solutions which are stored in a frozen form present a challenge to stable protein preparations because of the solute concentration effect that occurs during the freezing of solutions. An ideal strategy is to freeze the entire solution at the same time and rapidly at −80° C. where thermal transitions (such as eutectic melting) and glass transitions are minimized. This strategy, however, is not practical for large-volume solutions. Changes in solute concentration and pH during freezing procedures can also promote protein aggregation. An understanding of the appropriate formulation becomes critical when freezing and thawing is required.

Fill-and-finish operations may use pumps that can mechanically denature the protein because of shear stress or introduce impurities that serve as nucleation sources of protein aggregates. Some piston-displacement pumps, for example, can interact with protein drug product in a similar way that a car motor engine piston interacts with lubricant oil. The intimate contact between protein drug product and a piston rod can disrupt an otherwise stable drug product. Likewise, delivery systems introduce the complexity of container compatibility, and the resulting potential for protein aggregate formation.

Another important part of protein aggregation studies is evaluating the biological activity of the aggregate. Differences in biological activity of the aggregates compared to the activity of the monomeric protein can profoundly influence the potency of a protein-based drug. In such cases, product efficacy may be compromised. In general, a risk-based assessment of aggregates may warrant specific studies that may help elucidate which types of aggregates are more worrisome. A thorough investigation of the different environments to which the drug product is exposed during its lifecycle, including manufacture, storage, shipping freeze and thaw cycles, oxygen exposure, light, and physical stress, can provide a rationale for special degradation studies such as seeding or spiking of a specific aggregate or impurity into a protein solution to observe the potential for further aggregation.

The biopharmaceutical industry has experienced an increase in the number of analytical methods available to detect, characterize, quantify, and monitor aggregates in biopharmaceutical protein products. Size exclusion high-pressure liquid chromatography is the most widely used analytical method for protein aggregates such as dimers and LMW, and HMW species. The method is amenable to validation for high throughput analytical testing with good sensitivity, precision, resolution, and accuracy. However, as a chromatographic method, it can also induce aggregation, cause existing aggregates to be removed during sample preparation, or underestimate the presence of aggregates when HMW species cannot be discriminated or recovered. Perhaps the main limitation of SEC is that the elution buffer utilized often changes the aggregate characteristics of the sample being measured (e.g. causes increased aggregation, changes the structure of aggregates, or reverses aggregation). For therapeutic proteins, this often means a 100-fold dilution causing reversible soluble aggregates to disaggregate. Among the methods used for aggregate characterization, field flow fractionation (FFF), and dynamic light scattering (DLS) are capable of evaluating aggregates directly in solution (without dilution). FFF has a detection range broader than that of SEC, but data interpretation of concentrated samples may be difficult. DLS is a good quantitative method, but the read-out is proportional to surface area so large aggregates can mask detection of small ones if differences in size are not enough. Calorimetry is very useful to evaluate the stability of a protein solution because it can detect protein unfolding. Some methods may be combined to have a more powerful tool, such as mass spectrometry coupled to chromatography, which provides information on chemical and physical degradation. In addition, DLS in combination with SEC can overcome the limitations that may be encountered using either method, excepting the introduction of artifacts as a result of elution buffer components in the case of SEC.

### Electron Microscopy-Based Aggregate Analysis

Providing quantitative data on sub-visible aggregates present in a protein therapeutic, which can consist of aggregate nuclei smaller than 0.05 um that make up as little as 0.01% of the total therapeutic content, is an ongoing challenge that requires the development of new analytical approaches. Molecular electron microscopy, with its unique capability for providing direct visual information of size, shape, morphology, and aggregation of a sample close to its natural hydrated state, is a powerful new tool in the armamentarium of characterization techniques applied to protein therapeutics.

Molecular microscopy is a non-invasive molecular imaging technology that uses advanced specimen preparation and imaging methods designed specifically to visualize complex biological samples, under conditions close to their native state. For well-ordered samples such as viruses, and virus-antibody complexes, the achievable resolution can be <0.4 nm. High-throughput molecular microscopy combines robotic instruments, automated data collection and processing software, and a relational database into a pipeline to prepare, image, and analyze samples in a reproducible manner and with throughputs capable of addressing biopharmaceutical characterization needs in a statistically significant manner. Samples are preserved in solution by vitrification (using an automated cryogenic robot) or by negative stain, and then imaged using a transmission electron microscope (TEM) controlled by automated software that enables sampling of a significant portion of the specimen. Data is analyzed and stored in a secure database that tracks all aspects of sample preparation, imaging, and analysis to provide our current customers with a tightly controlled system for biological imaging.

Nanoparticle Size Distribution and Count. The methods for size distribution and count are implemented by a semi-automated particle-contouring program in which a human operator contours a nanoparticle, and a matlab script computes a variety of metrics, including the surface area encompassed by that contour. From the surface area, the area equivalent diameter (AED, nm) is calculated, which is the diameter of a circle of equivalent surface area. Size distribution of 100 nm latex beads was reproducible (p>>0.05) for three independent samplings of a single grid and measured a mean particle diameter of 95.4 nm with a spread about the mean of 6.9 nm. A dilution series confirmed that these methods could detect 2-fold differences (p<0.01) in particle count within the 10⁹-10¹⁰ beads/mL range with a precision of +/−16%. Based on these numbers, the number of images needed to detect 20 particles at a given particle count as would be about 132 images at 21,000× magnification and about 1 image at 6,500× magnification; corresponding to a detection limit of 5.0×10⁶ beads/mL for automated molecular microscopy methods. The area sampled would represent 0.1% of the specimen grid surface area and while the stated reproducibility and dilution series experiments indicate that this sampling is adequate for measuring particle size distribution and count, note that acquiring 200 images at 6,500× magnification would sample ˜20% of the specimen.

Nanoparticle Shape and Morphology. From the particle contours, a circularity measure is calculated (ratio of minimum to maximum Feret diameters, with 1.0 indicating perfect circularity). As expected, the circularity of 100 nm latex beads is very close to 1.0 at 0.957+/−0.003. Individual particles are also segmented from the image and reported as an image gallery for direct visualization of every particle measured.

Aggregation State. Two orthogonal measures have been developed to quantitate aggregation: 1) the ratio of total nanoparticle surface area observed relative to the area of the grid examined, called “aggregation extent”, and 2) a mathematical descriptor for monitoring relative IgG monomer loss, called “relative IgG monomer loss”. The “aggregation extent” metric is calculated by summing the surface areas of all observed particles to obtain “total particle surface area” in nanometers, and dividing this number by the total surface area of the specimen examined to get a fraction reported as a percentage. The descriptor for monitoring “relative IgG monomer loss” relies on having access to a control sample with n0 number of IgG monomers per field of view; from this the “relative IgG monomer loss” is calculated as N−N₀=(n₀−n)C₀/n₀ where n is the number of IgG monomers per field of view in the experimental sample, and C₀ is the initial concentration of IgG per μL. These metrics both have value when comparing different formulations of an antibody therapeutic, or subjecting a single therapeutic to stability testing, and while the “relative IgG monomer loss” metric requires fairly dilute IgG concentrations, the utility of monitoring the extent of aggregation via orthogonal measures in a single experiment will be an important validation step when initially evaluating a new formulation or stress factor. Moreover, dilution series can be utilized as calibration curves from which “absolute IgG monomer loss” can be calculated.

The “aggregation extent” metric comments on the ratio of the total surface area of all aggregates measured to the total surface area of the specimen that was examined. An aggregate however is a three-dimensional object, so in order to convert this “aggregation extent” metric into a meaningful value such as the amount of antibody in μg/mL sequestered into aggregates, 3D shape, or volume, may be beneficial. Tomographic reconstruction capabilities may be used to obtain the three-dimensional structure and shape of IgG aggregates, and such three-dimensional information may be used in conjunction with current shape descriptors (circularity, Feret's min/max diameter) to develop a mathematical model for inferring volume from the two-dimensional shapes of protein aggregates.

Improving Statistical Validity of Data Collection. In order to reduce user bias and improve the statistical validity of the method, an algorithm that allows random sampling of the grid substrate for data collection may be employed. This will ensure that a reasonable portion of the specimen is sampled for determination of particle count, monomer loss, and aggregation state. Automated data collection at higher levels of magnification proceeds in raster-fashion along a lattice of (x,y) points overlayed on the field of interest. This procedure can be extended to the atlas (low) level of magnification, by overlaying a similar lattice of (x,y) points at this level of magnification, and using a python scripted random-number generated to pick (x,y) targets for data collection at random.

Increasing Throughput of Data Collection and Analysis. The accuracy of these methods is directly dependent upon the ability to collect and process large numbers of images in an unbiased fashion. Automation of most of the steps required for data collection and analysis is a key component of keeping the costs of a technology that utilizes a multi-million dollar instrument low. The present methods may be performed using the Leginon (Potter et al., Ultramicroscopy 77: 153-61, 1999) platform for automated EM data collection; integrating automated particle contouring algorithms with the current Appion (Lander et al., J. Struct. Biol. 166: 95-102, 2009) platform for generation of size distribution and morphology metrics; and introducing further automation of existing data processing and analysis algorithms in Appion. The Leginon platform provides the ability to generate an atlas of the entire TEM grid, which already includes an assigned origin with associated (x,y) coordinates for locations on the grid. In order to integrate automated particle contouring algorithms with the Appion platform, the difference of Gaussians algorithm currently used in Appion is used to determine the center and approximate boundary of each aggregate, and standard image processing object contouring algorithms such as neighboring edge search (Voss et al., J. Struct. Biol. 166: 205-13, 2009; Vikal et al., Proc. SPIE. 2009; 7259:72594A; Chung and Chang, IEEE Trans Image Process. 12: 648-52, 2003; Zheng and Doermann, IEEE Trans Pattern Anal Mach Intell. 28: 643-9, 2006) may be used for accurate definition of particle contours. Further automation of existing processing and analysis algorithms required for monitoring monomer loss, reporting on aggregate size distribution and counts, and displaying aggregate morphology in the form of image galleries can make use of the AppionLoop function which has a built in ability to string together multiple existing Appion algorithms into a single, user-friendly “application”.

Reporting Results. When operated for external customers, the focus is on time efficient methods for reporting results in a manner that is easily interpreted and with the end-user in mind. Cost effectiveness will depend on limiting as much as possible the personnel time currently required for data analysis and presentation. Using automated data collection, analysis, and report generation, the present methods automate: 1) generation of graphs, plots, and tables that summarize aggregation metrics, and 2) presentation of this information into end-user friendly reports. In order to automate the data analysis required for graph, plot, and table generation, python scripting interfaces with the data analysis package MatLab and to incorporate these results into the current minimalistic report generation infrastructure within Appion. Finally, end-user friendly reports utilize python scripting to interact with data graphing package GraphPad Prism, which generates aesthetically pleasing graphs, plots, and tables in a variety of file formats. The advantage of containing data analysis and report generation within Appion is that this system already interacts with a relational database that tracks image collection by Leginon; thus, the final end-user report contains all information, from sample preparation, data collection, data analysis, through data interpretation in the form of graphs, plots, and tables.

One skilled in the art readily appreciates that the present invention is well adapted to carry out the objects and obtain the ends and advantages mentioned, as well as those inherent therein. The examples provided herein are representative of preferred embodiments, are exemplary, and are not intended as limitations on the scope of the invention.

### EXAMPLE 1

### EM Grid Preparation Methods

Samples were prepared for negative stain or preserved in vitrified ice supported by carbon coated 400 mesh copper grids by conventional methods. See, e.g., Quispe et al., Microsc. Microanal. 13:365-71, 2007 and Harris J R, editor, “Negative Staining and Cryoelectron Microscopy: the thin film techniques,” Oxford: BIOS Scientific Publishers Ltd, 1997, for suitable methods. Suitable negative stains include ammonium molybdate, uranyl acetate, uranyl formate, phosphotungstic acid, osmium tetroxide, osmium ferricyanide and auroglucothionate.

For negative stain preparation, antibodies were coupled with 8 mm colloidal gold according to Slot J W, Geuze H J (1985). Subsequently 5 μL of sample were incubated on the fresh glow-discharged carbon-coated grid 45 seconds, washed 3 times with water and 1 times with 2% fresh diluted and filtered uranyl acetate. Samples were stained in 2% uranyl acetate for 15-20 sec. Excess of stain was blotted off, and the grid allowed to air dry. Negative stain grids were stored at room temperature until transferred to the electron microscope for imaging.

For vitrified ice preparation, antibodies were coupled with 8 mm colloidal gold according to Slot J W, Geuze H J (1985). Subsequently 5 μL of sample were incubated on the fresh glow-discharged carbon-coated grid 45 seconds, blotted to a thin layer, and frozen in a liquid ethane slush. Frozen grids were stored under liquid nitrogen and imaged at approximately liquid nitrogen temperatures using a Gatan cryo stage.

### EXAMPLE 2

### EM Imaging

Electron microscopy was performed using an FEI Tecnai T12 electron microscope, operating at 120 KeV equipped with an FEI Eagle 4K×4K CCD camera. The grid was transferred into the electron microscope using a room-temperature stage (negative staining) or a cryostage that maintains the grids at a temperature below −170° C. (vitrified frozen). Images of each grid were acquired at multiple scales to assess the overall distribution of the specimen. After identifying potentially suitable target areas for imaging at lower magnifications, higher magnification images were acquired at nominal magnifications of 52,000× (0.21 nm/pixel) and 21,000× (0.50 nm/pixel). The images were acquired at a nominal underfocus of −4 μm (52,000×), and −5 μm (21,000×) at electron doses of ˜10-15 e/Å².

### EXAMPLE 3

### Image Processing

Images collected at multiple scales of magnification were inspected for appropriate quality by a human operator using the LEGINON web interface (Subway et al., J. Struct. Biol. 151: 41-60, 2005; Carragher et al., J. Synchrotron Radiation. 11: 83-85, 2004; Fellmann et al., J. Struct. Biol. 137: 273-282, 2002; Carragher et al., J. Struct. Biol. 132: 33-45, 2000; Potter et al., Ultramicroscopy 77: 153-161, 1999; Stagg et al., J. Struct. Biol. 155: 470-81, 2006). Images of poor quality were eliminated, and data of sufficient quality proceeded to image processing using the APPION web interface.

The “object tracing” module in APPION (Lander et al., J. Struct. Biol. 166: 95-102, 2009; Voss et al., J. Struct. Biol. 169: 389-98, 2010; Stagg et al., J. Struct. Biol. 163: 29-39, 2008) was used to independently process each magnification level, with options for contouring and identifying different categories of particles (aggregate, monomer, contaminant). The “size analysis” module in APPION was used to convert aggregate contours into perimeters and to calculate the area equivalent diameter, circularity, and other metrics, producing a size analysis report.

Monomer Loss Assessment. The “dog picker” module in APPION was used to select antibody monomers from high magnification data only. The “run alignment” module in APPION was used to align and classify selected monomers, and a human operator inspected the resulting classes to select classes containing real antibody monomers. The number of particles contributing to real antibody classes represents the number of free IgG molecules and was used to calculate % IgG loss relative to a reference sample, or to calculate absolute IgG loss using a standard curve.

### EXAMPLE 4

### Determining Changes in an IgG Specimen

The purpose of this experiment was to determine the extent of aggregation and the loss in free IgG monomers of a human IgG solution as a result of multiple kinds of stress as well as how those change over time for each respective stress.

A human IgG stock solution (10 mg/mL) was diluted to 0.5 ug/mL using PBS for a total end volume of 6.2 mL of the 5 μg/mL IgG solution. 1 mL of the solution was aliquoted into 6 microcentrifuge tubes.

A. Freeze/Thaw Cycling

For the freeze/thaw stress, 1 mL of PBS was added to 99 empty microcentrifuge tubes. The microcentrifuge tubes were placed into a freezer rack, leaving a space in the center. The sensor of a thermocouple was placed inside a microcentrifuge tube containing PBS adjacent to the empty space in the center of the rack. One IgG aliquot was placed into the empty space in the middle of the rack. The rack was placed into a −80° C. freezer and when the temperature on the thermocouple reached −70° C., the rack was removed from the freezer and allowed to thaw at RT. This freeze/thaw was repeated for a number of cycles.

B. Shear Force

For shear stress, 100 μL of SiO₂ beads in water were added to one IgG aliquot, and the aliquot secured to a platform shaker with masking tape. The platform shaker was allowed to rock back and forth for one hour at RT.

C. Shear Force (2)

For vortexing stress, one IgG aliquot was secured to a vortex mixer and permitted to vigorously mix for one hour at RT.

D. Heating

For heat stress, one IgG aliquot was placed into a heat bath set to 50° C. for one hour.

E. Gold Labeling

For the gold stress, 10 μl amine functionalized polymer caged gold nanoparticles (5 nm) was added to one IgG aliquot and mixed by pipeting.

F. Control

One IgG aliquot was maintained as a control without treatment.

For each test condition, grids were prepared as described above at Day 0, Day 1, Day2, Day 3, Day 7, Day 9, Day 14, Day 20 and Day 30.

The shear stress IgG sample had to be disregarded as the very high glass bead concentration made imaging and visualization of any free IgG or aggregates impossible. In the vortexed sample, no free IgG or aggregates were visible so that sample was disregarded as well. It is possible that vigorous vortexing for one hour could have disintegrated the IgG monomers impairing proper visualization.

Freeze/thaw and heat stress induced the largest aggregates. While the gold caused smaller aggregates, it increased the aggregate counts the most out of the stresses analyzed.

For both heat and freeze/thaw, aggregate formation was at the highest immediately after the stress (Day 0) then seems to reverse and decrease on Day 1. However by Day 7 it increased again. This could indicate that the stress induced aggregation was reversible but that after increased storage time, induced aggregation occurs.

In terms of free IgG concentration, freeze/thaw caused the most drastic drop in free IgG, followed by gold and then heat.

Consecutive fast freeze/thaw cycles produced increasingly larger aggregates and a dramatic drop in visible free IgG monomers. Consecutive slow freeze/thaw cycles produced increasingly larger aggregate counts and a gradual drop in visible free IgG monomers.

Aggregate size distribution (indicated by average aggregate AED measurements) increased for increasing freeze/thaw cycles for both the fast and the slow method, and became pronounced around the fourth cycle for both.

Aggregate counts increased over freeze/thaw cycles for the slow freeze/thaw and decreased for the fast freeze/thaw cycles. Combined with the size distribution and aggregate area this suggests that the fast/freeze thaw produces aggregate nuclei that grow in size with successive cycles whereas the slow freeze/thaw produces more aggregate nuclei with each cycle.

Aggregate shape, indicated by a circularity measurement, seemed to change with freeze/thaw cycles with the increasing fast freeze/thaw cycles resulting in less circular aggregates in relation to the slow freeze/thaw cycles.

In terms of free IgG loss, the fast freeze/thaw seems to produce a more drastic fall in free IgG monomers compared to a more gradual decrease seen in the slow freeze/thaw

While the invention has been described and exemplified in sufficient detail for those skilled in this art to make and use it, various alternatives, modifications, and improvements should be apparent without departing from the spirit and scope of the invention. The examples provided herein are representative of preferred embodiments, are exemplary, and are not intended as limitations on the scope of the invention. Modifications therein and other uses will occur to those skilled in the art. These modifications are encompassed within the spirit of the invention and are defined by the scope of the claims.

It will be readily apparent to a person skilled in the art that varying substitutions and modifications may be made to the invention disclosed herein without departing from the scope and spirit of the invention.

All patents and publications mentioned in the specification are indicative of the levels of those of ordinary skill in the art to which the invention pertains. All patents and publications are herein incorporated by reference to the same extent as if each individual publication was specifically and individually indicated to be incorporated by reference.

The invention illustratively described herein suitably may be practiced in the absence of any element or elements, limitation or limitations which is not specifically disclosed herein. Thus, for example, in each instance herein any of the terms “comprising”, “consisting essentially of” and “consisting of” may be replaced with either of the other two terms. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

Other embodiments are set forth within the following claims.

We claim:

1. A method of assigning a size distribution and aggregation metric to particles contained in an aqueous sample, wherein said particles are less than about 1 μm in diameter in a non-aggregated state, the method comprising:
a. collecting one or more transmission electron images of the aqueous sample at each of a plurality of different magnification levels, wherein each magnification level is between about 2000× and about 100,000×;
b. for each particle in a population of n particles identified in one or more of the images collected, determining a value for the surface area of the particle, and determining a particle size from the surface area value;
c. determining a distribution of the particle sizes of the n particles;
d. determining the total surface area of the non-monomer particles in the n particles (ΣSAₚ) by summing the surface area values determined for all non-monomer particles;
e. determining the total surface area (ΣSAᵢ), of the images containing the n particles;
f. determining the aggregation metric by dividing ΣSAₚ by ΣSAᵢ.

2. A method according to claim 1, further comprising assigning a shape metric to each particle in the population of n particles, the shape metric determined by calculating a ratio of the maximum and minimum Feret diameter for each particle.

3. A method according to claim 2, further comprising assigning a monomer loss metric to the particles contained in the aqueous sample.

4. A method according to claim 3, further comprising assigning a particle count metric to the sample.

5. A method according to claim 4, wherein the method further comprises determining the effect of one or more storage or handling conditions on the size distribution and aggregation metric of particles contained in the aqueous sample.

6. A method according to claim 5, wherein the storage conditions comprise freezing and thawing of the aqueous sample.

7. A method according to claim 5, wherein the storage conditions comprise heating of the aqueous sample above 25° C.

8. A method according to claim 5, wherein the storage conditions comprise maintaining the aqueous sample at a temperature above freezing for more than 1 day.

9. A method according to claim 5, wherein the storage conditions comprise lyophylization and rehydration of the aqueous sample.

10. A method according to claim 5, wherein the storage conditions comprise a variation in the material of the container in which the aqueous sample is stored.

11. A method according to claim 5, wherein the storage conditions comprise a variation in the volume of the aqueous sample.

12. A method, according to claim 5, wherein the storage conditions comprise a variation in the amount of the aqueous sample exposed to air.

13. A method, according to claim 5, wherein the handling conditions comprise shaking of the aqueous sample.

14. A method, according to claim 5, wherein the handling conditions comprise stifling of the aqueous sample.

15. A method, according to claim 5, wherein the handling conditions comprise adding non-biological material to the aqueous sample.

16. A method according to claim 1, wherein n is at least 10.

17. A method according to claim 1, wherein n is at least 50.

18. A method according to claim 4, wherein the size distribution and aggregation metric of particles contained in the aqueous sample are assigned in an automated analysis.

19. A method according to claim 1, wherein the transmission electron images are determined from the sample in a vitrified frozen hydrated state.

20. A method according to claim 1, wherein the plurality of different magnification levels comprise about 6,500× and about 21,000×.

21. A method according to claim 1, wherein the particles are selected from the group consisting of polymer beads, metal beads, proteins, viruses, virus-like particles, and liposomes.

22. A method according to claim 21, wherein the particles are antibodies.

23. A method according to claim 1, wherein the method is performed by a service provider as a service for a customer, and the method further comprises generating a report of the results obtained from the method for delivery to the customer.
